(19) United States
(12) Patent Application Publication
(10) Pub. No.: US 2015/0371262 A1
(43) Pub. Date: Dec. 24, 2015

(54) Internet Search Engine Advertisement Optimization

(71) Applicant: Pure Auto LLC dba PureCars, Charleston, SC (US)

(72) Inventors: Jeremy Anspach, Charleston, SC (US); S. Ashley Messer, Atlanta, GA (US); Adam Phillips, Atlanta, GA (US)

(73) Assignee: PURE AUTO LLC DBA PURECARS, Charleston, SC (US)

(21) Appl. No.: 14/312,231

(22) Filed: Jun. 23, 2014

(51) Int. Cl. G06Q 30/02

(52) U.S. Cl. CPC G06Q 30/0256

(57) ABSTRACT

The present invention enhances the internet search experience for buyers researching their next vehicle purchase using an internet search engine. Specifically, some embodiments allow for the optimization of online ad campaigns so that internet search results yield sponsored advertisements in particular relevance to search inquiries. In some cases, an ad campaign has one or more ad groups, each ad group associated with positive keywords and negative keywords, ad creative, and a dynamic landing page. The hierarchical structure of the ad campaigns allows the advertiser to funnel searches to the most relevant advertisements.

### FIELD OF INVENTION

This invention relates to systems, methods, and devices for enhancing the experience for buyers researching their next vehicle purchase using an internet search engine.

### BACKGROUND OF THE INVENTION

Currently, when a consumer uses an internet search engine such as Google®, Yahoo®, Bing®, or the like, to search for a specific type of vehicle, the most relevant and first-listed search results often link to car manufactures and car dealer websites. Then, upon clicking the link, the consumer must navigate the manufacturer's or dealer's website, and may perform the same search again and again using each website's search widget. For example, a search for “new Chevy trucks” may yield links to www.Chevrolet.com, various Chevy dealerships, and even to a Ford dealer's website. Once inside any of those sites, further navigation is required to view a page devoted to “new Chevy trucks.”

Although the revenue model for search engines often revolves around paid advertisements, search engines will often promote paid ads that are more relevant to a consumer's search. A highly relevant ad may, therefore, be rewarded with a lower price and a better position on the page.

Notwithstanding this incentive, searching for used vehicles tend to produce irrelevant advertisements. For example, a simple search for “2012 Chevy Silverado” often yields sponsored advertisements that either don't recognize that used cars are desired (“Get Your New Silverado Today”) or don't recognize that a Silverado model is desired (“Huge Selection of Chevrolets”). Furthermore, if a consumer does decide to click on one of the ads, they are either taken to the home page of the dealership or, at best, to a dealership's search results page. Only once inside a dealer's website can the consumer navigate to the specific type of vehicle desired by the consumer.

The tedious nature of internet searching for vehicles can annoy and discourage the consumer. Moreover, it can cost a dealership a sale. That cost is especially regrettable because even if the dealership has the exact make, model, year and trim that the consumer seeks, the dealership cannot communicate this effectively. With current technology, dealers may inadvertently drive the consumer away with voluminous and irrelevant information.

### BRIEF DESCRIPTION OF THE DRAWINGS

FIG. 1 provides a schematic diagram depicting an exemplary computer environment 100 for use with one or more embodiments.

FIG. 2A provides a schematic diagram of one embodiment of a system according to the present invention, in which dynamic landing pages 242, ad campaigns 232, and ad groups 234 are produced.

FIG. 2B provides a schematic diagram of another embodiment of a system according to the present invention, in which dynamic landing pages 242 and ad groups 234 are produced.

FIG. 3 provides a schematic diagram of another embodiment, in this case a campaign building module 230 in electronic communication with a dynamic landing page building module 240.

FIG. 4 depicts a flow chart for one exemplary method for practicing the present invention.

FIG. 5 depicts examples of ad campaigns 511-516 and exemplary ad groups 521-526, 531-536 that can be associated with those ad campaigns.

FIG. 6 depicts schematically an embodiment of an ad group 234.

FIG. 7 provides a hypothetical example of an ad creative 650.

FIG. 8 depicts schematically an embodiment of an internet search engine result page 810 showing an example of an ad creative 650 according to the present invention.

FIG. 9 depicts schematically a hypothetical embodiment of a dynamic landing page 910 for a fictional seller having three suitable vehicles responsive to the search inquiry, “new Chevy trucks.”

### DETAILED DESCRIPTION

Detailed embodiments of the present invention are disclosed herein; however, it is to be understood that the disclosed embodiments are merely exemplary of the invention that may be embodied in various forms. A person of ordinary skill will appreciate from the description herein that modifications can be made to the described embodiments and therefore that the disclosure is broader in scope than any described embodiment. All examples are therefore non-limiting. The figures are not necessarily to scale, and some features may be exaggerated to show details of particular components. Therefore, specific structural and functional details disclosed herein are not to be interpreted as limiting, but merely as a basis for the claims and as a representative basis for teaching one skilled in the art to variously employ the present invention.

Wherever the phrase “for example,” “such as,” “including” and the like are used herein, the phrase “and without limitation” is understood to follow unless explicitly stated otherwise. Similarly “an example,” “exemplary” and the like are understood to be non-limiting.

The term “substantially” allows for deviations from the descriptor that do not negatively impact the intended purpose. Descriptive terms are understood to be modified by the term “substantially,” even if the word “substantially” is not explicitly recited.

The term “about” when used in connection with a numerical value refers to the actual given value, and to the approximation to such given value that would reasonably be inferred by one of ordinary skill in the art, including approximations due to the experimental and or measurement conditions for such given value.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a device having components a, b, and c” means that the device includes at least components a, b and c. Similarly, the phrase: “a method involving steps a, b, and c” means that the method includes at least steps a, b, and c.

As used herein, an “ad campaign” refers to an internet advertising effort organized into ad groups and described by a set of generic criteria. For example, an ad campaign for “used make and model,” may contain ad groups for pre-owned vehicles based on the makes and models of those vehicles, such as “Used Toyota 4Runner,” “Used Chevy Silverado,” and the like. In certain cases, an ad campaign may also include ad campaign-level negative keywords.

As used herein, “ad group” refers to a collection of positive keyword(s), negative keyword(s), and ad creative, all limited by a specific set of attributes. For example, an ad group “Honda Civic” may be limited to referencing vehicles that are both Hondas and Civics. If the ad group is in the “used make and model” ad campaign, then the ad group may be additionally limited to searches for pre-owned vehicles.

As used herein, “speculative search” refers to a search phrase that a specific ad group is intended to capture. Although an ad group for “Black 2003 Infiniti G35” might exist to be responsive to a hypothetical search for a “used black or grey 2000-2005 infiniti G35,” the search is speculative because it is possible that no consumer actually searches for that exact phrase.

As used herein, “ad creative” refers to a collection of data configured to be displayed on a search engine results page in response to an appropriate search inquiry on the search engine. Ad creative may include, for example, a title, a display URL, a destination URL (which is often different from the display URL), body copy that may include one or more attributes of the vehicles having the specific set of vehicle attributes for the ad group, and extensions (any other information that the search engine allows to be displayed, such as other site links, location, phone number, additional details about relevant vehicle offerings, etc.). In certain embodiments, an ad creative may additionally include multimedia elements, such as sound, image and video.

As used herein, “dynamic landing page” refers to a webpage that is displayed when a consumer's browser follows the destination URL in the ad creative.

As used herein, “URL” refers to a uniform resource locator, the address (either dynamic or static) of resources on the internet. However, those skilled in the art will understand that the protocol identifier portion of the URL is often truncated so that http://www.example.com can be shortened to www.example.com in certain circumstances.

As used herein, “positive keywords” refers to a collection of search terms that are limited to the specific set of vehicle attributes for an ad group. Positive keywords can include synonyms for the limiting vehicle attributes. For example, the ad group “Used Chevrolet Corvette” can include “Chevy,” “Chevrolet,” “Corvette,” “Vette,” and possible misspellings such as “Shevy,” “Corvet,” “Korvet,” and “Vet.” Plurals such as “Corvettes” may be used as additional search terms, and both “pre-owned” and “used” may be used. Furthermore, additional terms, such as “sale,” “for sale,” “dealer,” “dealership” may also be included as possible search terms. The search terms may include both phrases (where the ordering of words is important) and single words.

As used herein, “negative keywords” refers to a collection of search terms that are excluded from the specific set of vehicle attributes. Negative keywords may be applied on either the ad group-level or the ad campaign-level. Negative keywords can include synonyms for other negative keywords. For example, the ad group “Toyota 4Runner” can include as negative keywords “Chevy,” “Chevrolet,” “Corvette,” “Vette,” and possible misspellings such as “Shevy,” “Corvet,” “Korvet,” and “Vet,” among many other possible negative keywords, such as, for example, “RAV4,” “Highlander,” “Sequoia,” “Land Cruiser,” “Ford,” and “Range Rover.” Negative keywords govern the scope of the search, and ensure searches get funneled to the most relevant ad campaign or ad group. For example, the ad group “Used Toyota SUV” in the “used make and body” ad campaign can have as negative keywords, “RAV4,” “Highlander,” “4Runner,” “Sequoia,” and “Land Cruiser,” (i.e., the entire line of Toyota SUVs) so searches for those terms go to more-focused ad groups in the more relevant “used make and model” campaign (e.g., the “Used Toyota 4Runner” ad group).

As used herein, “device” indicates a piece of computer hardware that alone or in combination with other computer hardware can execute program code. Examples of computer hardware include, but are not limited to, processors; memory; storage; output devices including visual interfaces such as for example, screens and touch screens; and input devices such as, for example, keyboards, pointing devices such as computer mouses (mice), buttons, touch screens, touch pads, and microphones.

As used herein, “seller” refers to any person or entity offering one or more vehicles for purchase, either wholesale, fleet, or retail. A seller can be, for example, a manufacturer, importer, wholesale distributor, car dealership, or individual.

As used herein, “vehicle” refers to any motorized machine designed to transport people or freight and is generally defined by ISO 3833. Automobiles, motorcycles, scooters, limousines, sport-utility vehicles, vans, minivans, trucks, minibuses, buses, recreational vehicles, and tractor-trailers may be mentioned as examples of vehicles. Thus, embodiments of the present invention may relate to automotive sales, while other embodiments relate to motorcycle sales, while still other embodiments related to all vehicular sales. Embodiments described for automotive sales are equally applicable to embodiments for other types of vehicle sales.

As used herein, “template” refers to a data structure designed to organize certain data. For example, digital vehicle inventory data may be stored differently from one seller to the next. A template will receive that data and organize it into a record that is readable by the various modules of the several embodiments of the present invention. In some cases, for example, the digital vehicle inventory data for a single vehicle can be organized by template into a record uniquely identified by the vehicle's Vehicle Identification Number (VIN), and include one or more fields, whether each field is populated or not, such as, for example, make, model, year, body style, trim, interior color, exterior color, mileage, certified status, used status, new status, transmission type, engine, fuel economy rating, leather seats, heated seats, third row seating, navigation system, Bluetooth®, satellite radio, keyless entry, tow hitch, power lift gate, telematics, wireless connectivity technology (other than Bluetooth®),iPod® adapter, back up camera, sun roof, warranty, seller, seller location, vehicle location, price, accident reports, number of previous owners, and maintenance history.

As used herein, “electronic communication” refers to the ability of one module, component, device, or system to send to or receive data from another module, component, device, or system. Electronic communication can be provided by any suitable means. In some cases, electronic communication occurs within a chip, across a motherboard, by cable, wirelessly, via a cellular network, via the internet, or a combination of the foregoing.

The definitions of other words will be apparent to those skilled in the art from the context in which they are presented.

Applicants have invented systems, methods, and devices that can enhance the experience for consumers researching their next car purchase. In contrast to the tedious and repetitive search experience offered by current technology, some embodiments of the present invention allow a search engine inquiry to yield a relevant advertisement and a link to a seller's dynamic landing page. In such an embodiment, both the advertisement and the landing page highlight only vehicles that are relevant to the search inquiry. In one embodiment, “New Chevy trucks” will display new Chevy trucks offered by the seller, and a search for “2012 Chevy Silverado with crew” will display in-stock 2012 Chevy Silverados having a crew cab. In those instances, the consumer's experience is enhanced, and the seller sponsoring the advertisement quickens the transition from shopping to buying, by immediately and efficiently identifying relevant inventory. In certain embodiments, assigning relevant terms as positive and negative keywords in different ad groups and organizing ad campaigns to address different consumer search strategies accomplishes this.

For example, a consumer searching the internet for “Toyota 4Runner” likely only wants to see only 4Runners, and is less interested in RAV4s, Highlanders, Sequoias, Land Cruisers, Chevys, Fords, or Range Rovers. On the other hand, a consumer searching for “Toyota SUV” may be interested in all RAV4s, Highlanders, 4Runners, Sequoias, and Land Cruisers in stock. If a seller does not have the specific vehicle in stock, one embodiment of the invention would allow the advertisement and landing page to display a different in-stock vehicle that is closest to the searcher's request (e.g., a Jeep Grand Cherokee instead of a Toyota 4Runner).

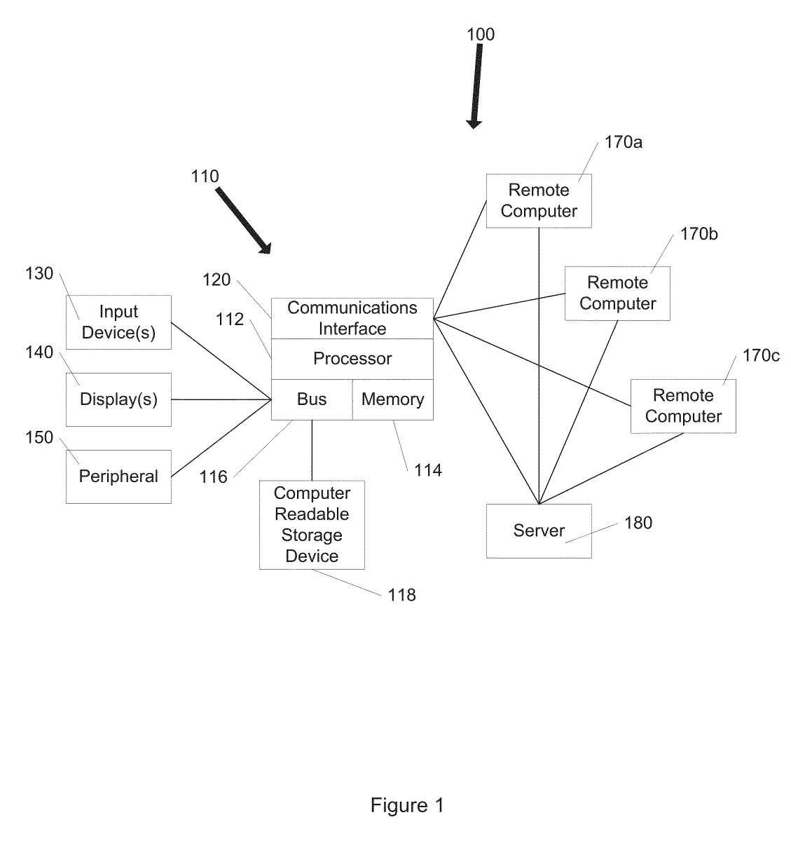

To provide additional context for various aspects of the exemplary embodiments disclosed herein, the following is a description of a suitable computing environment 100 depicted in FIG. 1 in which the various aspects of the exemplary embodiments may be implemented. While the exemplary embodiments disclosed herein relate to computer-executable instructions that may run on one or more computers, those skilled in the art will recognize that the exemplary embodiments may be implemented in combination with other program modules or as a combination of hardware and software.

Referring to FIG. 1, an exemplary computing environment 100 for implementing various aspects of the invention may include a computer 110 that includes a processor 112, system memory 114, a system bus 116, and a communications interface 120. The system bus 116 couples system components to one another. The processor 112 may be any of various processors including those that are commercially available. Moreover, multi processor architectures may be employed as the processor 112.

The system bus 116 may be any of several types of bus structure that may further interconnect to a memory bus (with or without a memory controller), a peripheral bus, and a local bus using any of a variety of bus architectures including those commercially available. The system memory 114 may include read only memory (ROM) and/or random access memory (RAM). A basic input/output system (BIOS) may be stored in a non-volatile memory such as ROM, EPROM, EEPROM, which BIOS contains the basic routines that help to transfer information between components within the computer 110, such as during start-up. The RAM may also include a high-speed RAM such as static RAM for caching data.

The computer 110 may further include computer readable storage device 118, which may comprise one or more devices. Computer readable storage device 118 may comprise any suitable media that can be accessed by the computer 110 and includes both volatile and nonvolatile media, removable and non-removable media. Computer readable storage device 118 may include generally any method or technology for storage of information such as computer readable instructions, data structures, program modules or other data. Computer readable storage device 118 can be chosen from, without limitation, RAM, ROM, EEPROM, flash memory or other memory technology, CD ROM, digital video disk (DVD) or other optical disk storage, magnetic cassettes, magnetic tape, magnetic hard disk storage, magnetic floppy disk storage or other magnetic storage devices, or any other medium which may be used to store the desired information and which may be accessed by the computer 110, whether internal or external.

The computer readable storage device 118 may store a number of program modules, including an operating system, one or more application programs, other program modules and program data. All or portions of the operating system, applications, modules, and/or data may also be cached in the RAM. It should be appreciated that the exemplary embodiments may be implemented with various commercially available operating systems or combinations of operating systems.

Generally, program modules include routines, programs, components, data structures, etc., that perform particular tasks or implement particular abstract data types. Moreover, those skilled in the art will appreciate that aspects of the exemplary embodiments may be practiced with other computer system configurations including, without limitation, single-processor or multiprocessor computer systems, minicomputers, mainframe computers, cloud servers, as well as personal computers, hand-held wireless computing devices, cell phones, smart phones, tablet computers, smart watches, smart glasses, microprocessor-based or programmable consumer electronics, each of which can be operatively coupled to one or more associated devices. Aspects of the exemplary embodiments may also be practiced in distributed computing environments where certain tasks are performed by remote processing devices that are linked through a communications network. In a distributed computing environment, program modules may be located in both local and remote memory storage devices.

It is within the scope of the disclosure that a user may enter commands and information with respect to the computer 110 through one or more wired/wireless input devices 130. Exemplary input devices 130 include, without limitation, a keyboard and/or a pointing device, such as a mouse. Other input devices 130 may include a microphone (functioning in association with appropriate language processing/recognition software as is known to those of ordinary skill in the technology), an IR remote control, a joystick, a game pad, a stylus pen, or the like.

A display 140 for the computer 110 may also be connected to the system bus 116. In exemplary form, the display 140 may comprise a monitor or, if it is combined with the input device 130, a touch screen that is operative to send inputs to the computer 110.

The computer 110 may further include one or more peripheral output devices 150 such as, without limitation, a speaker or a printer that are communicatively coupled thereto.

The computer 110 may operate in a networked environment and be communicatively coupled to one or more remote computers 170a, 170b, and 170c through a communication interface 120, such as a modem or network card.

The remote computer(s) 170 may be a workstation, a router, a personal computer, a portable computer, a cellular device, an entertainment appliance, a peer device or other common network node, and may include many or all of the elements described relative to the computer 110. The computing environment 100 may also include a server 180 as one of the remote computers 170.

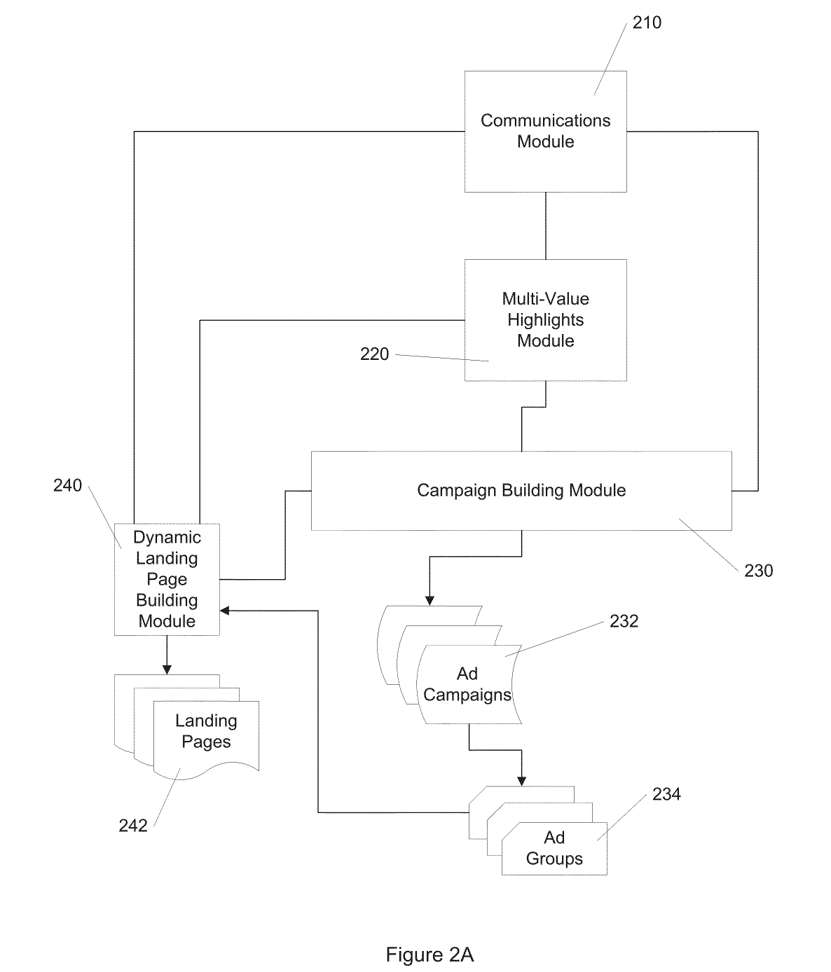

FIG. 2A illustrates a schematic diagram of a system in which dynamic landing pages 242, ad campaigns 232, and ad groups 234 are produced. Communications module 210 (operating, for example, in computing environment 100 (see FIG. 1)) receives digital vehicle inventory data from a seller, such as a dealership, and passes the digital vehicle inventory data to a multi-value highlights module 220 via electronic communication. The multi-value highlights module 220 applies a vehicle attributes template to the digital vehicle inventory data and creates a record for each vehicle in inventory. The mutli-value highlights module may use the communications module 210 or internal resources to populate each record with information from databases in addition to the digital vehicle inventory data, such as VIN decoders, vehicle history providers (e.g., CarFax®), maintenance records, certification and warranty databases and build data from manufacturers. Once collected, the multi-value highlights module 220 would then rank the features of each vehicle. The top six features for one vehicle may be that it has (1) navigation system, (2) backup camera, (3) Bluetooth®, (4) heated front seats, (5) leather seats, and (6) third row seating, while another vehicle's top six features might be (1) priced below market, (2) certified pre-owned, (3) one previous owner, (4) low mileage, (5) Bluetooth®, and (6) heated front seats. The records that constitute the seller's vehicle inventory are then passed by electronic communication (with either push or pull technology) to the campaign building module 230, which builds and manages various ad campaigns 232 and ad groups 234 based on the attributes present in the digital vehicle inventory data. The multi-value highlights module 220 is substantially similar to the value engine described in the copending U.S. patent application filed on date even herewith by Jeremy Anspach and Jason Kuykendall and titled “Comment Generator for Vehicles.”

As an example, the campaign building module 230 might manage various ad campaigns 232 that can include: Brand, New Make, New Model, New Make Model, New Make Body, New Year Make Model, New Year Make Model Trim, Used Make, Used Model, Used Make Model, Used Make Body, Used Year Make Model, Used Year Make Model Trim, Combined Model, Combined Make Model, Combined Make Body, Combined Year Make Model, Combined Year Make Model Trim, Parts, and Service. Each ad campaign 232 is designed to anticipate a car buyer's intent in typing a search term in a search engine.

For example, the “Brand” ad campaign 232 is designed to reach consumers who are looking for a specific seller. If the seller is “Anderson Acura,” then positive keywords might include searches for the exact phrase “Anderson Acura” and the individual words “Anderson” and “Acura.” In such a situation, a consumer is most likely just looking for “Anderson Acura's” internet presence. Accordingly, generic advertisements, seasonal promotions, manufacturer specials or other eye-catching ad creative might be used.

Portions of the ad creative might be generated dynamically, depending on the inventory. For example, the campaign building module 230 might analyze relevant data in order to generate an ad that might read, “Anderson Acura. 145 New Acuras in-stock. 29 Used Cars Available. Only 17 Days Left To Save In Jan.” Specifically, the campaign building module 230 would determine the number of new cars in inventory (145), the number of used cars in inventory, including all makes and models (29), the current month (Jan.) and how many days are left in the month (17). Although the display URL (e.g., “andersonacura.com”) would also typically appear somewhere in the ad creative, it has been omitted for clarity.

In contrast, the ad campaign 232 “Used Year Make Model” is designed to reach consumers who have a very good idea of the vehicle they are looking for, but may not be specifically looking for “Anderson Acura.” The campaign building module 230 would create or manage ad groups 234 that represent each available car by make, model, and year. In the “Anderson Acura” example, there would be a maximum of 29 active ad groups 234 in the “Used Year Make Model” campaign 232, which might include “2001 Acura CL,” “2003 Honda Accord Sedan,” “2003 Infiniti G35,” “2005 Acura MDX,” etc. There would be less than 29 ad groups 234 if the dealership had multiple cars of the same year, make and model (e.g., if there were two 2005 Acura MDXs, then both vehicles would be reflected in the “2005 Acura MDX” ad group 234. If “Anderson Acura” had a single 2010 Acura TSX, and after the multi-value highlights module 220 ranked all of its various features and determined that its top three features were that it (1) was certified, (3) only had one previous owner, and (3) had a lower mileage than other 2010 vehicles, then the campaign building module 230 might create the following highly-relevant ad creative: “Used 2010 Acura TSX. Priced At $22,995. Certified, One Owner, Low Miles.” A single template could be used to generate the exemplary ad creative for all ad groups 234 in the “Used Year Make Model” ad campaign. The template might be generalized to “Used <year> <make> <model>. Priced At <price>. <top value highlight>, <second value highlight>, <third value highlight>.” where variables are indicated by the chevrons. The positive keywords and the negative keywords for a “2010 Acura TSX” ad group would ensure that such an ad creative would appear only to a consumer who specifically searched for a 2010 Acura TSX (or minor variations thereof). Other templates could be used in the case of multiple cars having the same year, make and model.

The ad campaign 232 “Combined Make Body” is for consumers who are still early in their research. There may only be two ad groups 234 in the ad campaign 232: “Acura Car” and “Acura SUV.” The “Combined” ad campaigns 232 would be designed for consumers who do not yet know or have not specified whether they want a pre-owned or new vehicle. If a user searched for “acura suv sale,” the campaign building module 230 might deliver ad creative that reads, “99 New & Used Acura SUVs. Some With Nav, Backup Cam, Leather. RDX, MDX Available.” The associated template might be “<no. new Acura plus no. used Acura> <“New” if no. new Acura greater than 1> <“&” if both no. new Acura and no. used Acura greater than 1> <“Used” if no. used Acura greater than 1>. <“Some” if more than 1 Acura> With <top value highlight of all Acuras>, <second value highlight of all Acuras>, <third value highlight of all Acuras>. <Most expensive model available>, <second most expensive model available> available.”

It should be appreciated by those skilled in the art that a single ad group 234 might have multiple templates that deliver slightly different ad creative. Ad effectiveness could then be monitored to determine which advertisement is most successful. For example, click through rate could be compared for the above ad (“99 New & Used Acura SUVs. Some with Nay. Backup Cam, Leather. RDX, MDX Available.”) and “99 New & Used Acura SUVs. Starting at $7,995. Find the Acura SUV to Suit Your Lifestyle.”

Although not listed in the exemplary ad campaign 232 described above, other ad campaigns tailored to specific markets are possible. Any features identified by the multi-value highlight module 220 could be used to further refine the ad campaigns. For example, all “Used” campaigns (i.e., Used Make, Used Model, Used Make Model, Used Make Body, Used Year Make Model, and Used Year Make Model Trim) could be further subdivided into Uncertified and Certified campaigns. In such an embodiment, consumers that searched for a “certified 2010 honda accord” would be preferentially directed to inventory that is certified (by the factory, a third party, or the dealer itself). Similarly, other features such as color, below market price or price ranges (e.g., “$10,000 to $15,000” or “below $20,000”) could similarly be implemented.

The dynamic landing page building module 240 is activated when a consumer clicks on the ad creative. Although the ad creative's destination URL is created by the campaign building module 230, in the depicted embodiment, the actual landing page 242 is not generated until a consumer clicks on the advertisement. Once clicked, the dynamic landing page building module 240 analyzes the destination URL and data from the campaign building module 230 in order to determine which ad group 234 was triggered.

If the ad group 234 was “2014 Acura TSX 4dr Sdn 14 Auto Tech Pkg” in the ad campaign 232 “New Year Make Model Trim” then the landing page would be designed to be relevant to the consumer's interest. For example, if a consumer searched for some variant of a 2014 Acura TSX sedan with the technology package (perhaps searching for a “new acura TSX with backup camera”), then the landing page 242 would be a web page highlighting the details of relevant in-stock vehicles. Relevant in-stock vehicles need not be restricted to the same year, make, model and trim, but might also include similar in-stock vehicles that consumers consider when they research the 2014 Acura TSX sedan with the technology package. As would be apparent to those skilled in the art, relevant in-stock vehicles for such a specific search would not typically be an alphabetical listing of all inventory. Rather, in some cases, “highly relevant” in-stock vehicles include only those in-stock vehicles matching the searched-for criteria. In other cases, “moderately relevant” in-stock vehicles include in-stock similar vehicles missing one or more of the searched-for criteria. In cases of a mistake, “moderately relevant” vehicles may be the most relevant vehicles possible. For example, there are four Honda Accord models: the Honda Accord Sedan, Honda Accord Coupe, Honda Accord Plug-In, and the Honda Accord Hybrid. However, only the Honda Accord Sedan has a “Sport” trim level. Therefore, a search for “honda accord plug-in with sport trim” cannot produce an exact match, because no such car exists.

Preferably, the landing pages 242 have the functionality to display the seller's entire inventory through appropriate navigation. In one embodiment, after the consumer has visited the relevant page, which may only contain a handful of vehicles, the consumer has the option to browse the site to find other new cars, used cars, specials, the service department, the parts department, and the body shop through standard website navigation options. In such an embodiment the landing pages 242 would have much of the same functionality as the seller's normal website. Accordingly, landing pages 242 could entirely take the place of the seller's normal website, integrate with the seller's normal website, or stand in parallel with the website. In the latter two cases, if someone manually typed in “www.andersonacura.com,” they would be taken to the seller's normal website, and only if they clicked on an advertisement generated by the campaign building module 230 would they be taken to landing pages 242. A third party could manage the seller's landing pages by registering a CNAME record, which allows an alias to be created so that, for instance, “landing.andersonacura.com” (and all directories thereof) is actually managed by servers located at, for example, thirdpartyadvertisingcompany.com. In such an example, a destination URL for the “Acura RDX” ad group in the “Used Model” ad campaign might be landing.andersonacura.com/used/all/Acura/RDX?_vsrefdom=USED, which is then sent to the thirdpartyadvertisingcompany.com's servers, which can then access the dynamic landing page building module 240 to translate the request and present an appropriate landing page 242.

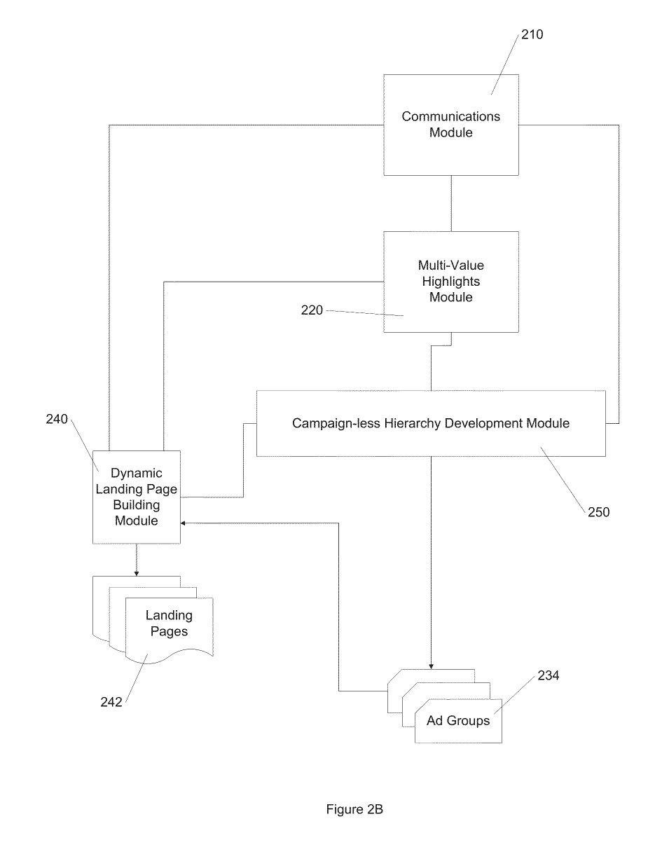

FIG. 3 shows a more detailed instance of a campaign building module 230. This campaign building module 230 includes an ad group builder module 350 which in turn contains an ad creative builder module 360 and a positive keyword module 370. The ad group builder module 350 processes records of digital vehicle inventory data to associate a given set of attributes to a given ad group 234. Ad group builder module 350 accesses the dynamic landing page building module 240 to build a landing page for the ad group 234, which landing page 242 is linked on the ad creative for the ad group 234 by the ad creative builder module 360. Attributes associated with the ad group 234 are identified as positive keywords through the positive keyword module 370. A negative keyword module 380 assigns negative keywords to the ad group 234, and a merge function 390 associates the negative keywords with the ad creative and positive keywords for the ad group 234.

The negative keyword module 380 can be built in a variety of ways. In one embodiment, negative keywords are taken from a library of every make, model and trim level for every possible vehicle. Each ad group 234 would then use the same library, modifying the library for each particular ad group 234. For example, the “2014 Acura TL” ad group in the “New Year Make Model” ad campaign would use the entire negative keyword library except for the terms “Acura,” and “TL.” “Acura” and “TL,” along with other relevant positive keywords would be produced by positive keyword module 370. Every other make and model would therefore be excluded from the ad group 234. Even Acura TL trims (e.g., the “TL SH-AWD” trim) would be excluded, as those searches would be picked up by the relevant ad group 234 in the “New Year Make Model Trim” ad campaign 232. It should be appreciated, however, that certain modifications might be appropriate, depending on how many ad campaigns 232 are used. For example, in the embodiment described in connection with FIG. 2A, the only ad campaign for used vehicles including trims is the “Used Year Make Model Trim” ad campaign. If a consumer searched for a “used honda accord sport,” but did not search for a particular year, then the relevant ad campaign would be “Used Make Model.”

Depending on the desired implementation, the “Used Honda Accord Sedan” ad group in the “Used Make Model” ad campaign could either have no Honda Accord Sedan trim levels as negative keywords or only out-of-stock Honda Accord Sedan trim levels. Therefore, if the seller had two Honda Accord Sedans: a 2011 EX and a 2012 EX-L V6, then negative keywords in the “Used Honda Accord Sedan” ad group might include “LX,” “Sport,” and “Touring” (the out-of-stock trim levels) while the positive keyword module 370 would produce keywords of “EX” and “EX-L V6.” In this example, out-of-stock trim levels would not trigger any advertisements and a search for in-stock trim levels without a model year would trigger an ad from the “Used Make Model” ad campaign.

Furthermore, the negative keyword module 380 may be further optimized to utilize ad campaign-level negative keywords. If a sub-set of negative keywords applied to every ad group 234 in an ad campaign 232, then those negative keywords could be used on the ad campaign level. For example, an ad campaign 232 “New Make Model” might include negative keywords such as “used,” “pre-owned,” certain previous model years (those model years where the seller has no new models in-stock), and the like.

Whether a seller would want to include out-of-stock trim levels or other attributes among positive keywords would depend on whether the seller was interested in maintaining an ad presence or “conquesting”—the practice of deploying advertisements intended to change a consumer's mind. Although an advertisement for a Honda Accord EX might not be precisely relevant to a search for a Honda Accord LX, it might be the most relevant vehicle in the seller's inventory. Similarly, the seller might include all trim levels or just in-stock trim levels as positive keywords in the ad group 234. In this context, “similar vehicles” would include both highly relevant vehicles that exactly match the searcher's request and moderately relevant vehicles that do not exactly meet the searcher's request. Moderately relevant similar vehicles might be derived by broadening a search, perhaps by removing or replacing a trim level, expanding the model year, or ignoring explicitly searched-for options (e.g., leather seats). Moderately relevant similar vehicles might also be derived by using logic that more generally matches the body type so that a “2009 honda odyssey with dvd” shows results for a 2009 Toyota Sienna with a DVD system. These and other changes can be made according to any suitable method, such as by manual data entry, or by programmed logic applied at any suitable point such as when the multi-value highlights module 220 applies templates to the digital vehicle inventory data, or by the campaign building module 230.

In another embodiment of the negative keyword module 380, every positive keyword that is used in the positive keyword module 370 could be a potential negative keyword. If the “Used Acura MDX” ad group in the “Used Make Model” ad campaign used only the following eight positive keywords: “used,” “pre-owned,” “acura,” “mdx,” “mdxs,” “sale,” “dealer,” and “dealership,” then the negative keywords for that ad group would be every other search term used by any other ad group 234. Accordingly, in this embodiment, the “master list” of negative keywords would be populated by the aggregation of all positive keywords. Removing one ad group's positive keywords from the master list would create the negative keywords for that specific ad group. If ad campaign-level negative keywords were used, then the negative keywords for a specific ad group would also exclude those negative keywords that are already being used at the campaign-level. This can be done iteratively, as each ad group is created and positive keywords populated, or after all ad groups' positive keywords assigned, or any other suitable method, including a combination thereof.

In one embodiment, the merge function 390 does not simply combine ad creative, positive keywords and negative keywords for submission to a search engine, but additionally compares the generated ad campaigns 232, ad groups 234 and ad creative with historical ad campaigns 232, ad groups 234 and ad creative. The campaign building module 230 only submits changes from the last update (often multiple times in a day) to the search engine. Often search engines gauge relevance based, in part, on historical performance, so it is beneficial to maintain a history by continuing ad campaigns 232, ad groups 234 and ad creative and not overwriting or deleting them. If, for example, a particular dealership sold its last 2008 Toyota Camry, it is likely that, at some time in the future, the dealership will have another 2008 Toyota Camry in stock. Accordingly, the campaign building module 230 would pause the 2008 Toyota Camry ad group 234 and ad creative, allowing them to reactivate later without losing their histories through deletion.

As described in the depicted embodiment of FIGS. 2A and 3, campaigns are useful for both organizational simplicity and applying campaign-level negative keywords. However, those skilled in the art will readily recognize that campaigns are a mere convenience, and an appropriate hierarchy can be created with only ad groups 234. FIG. 2B replaces the campaign building module 230 with a campaign-less hierarchy development module 250 that creates only ad groups 234. Accordingly, the only difference between the campaign building module 230 of FIG. 2A and the campaign-less hierarchy development module 250 of FIG. 2B is the creation of campaigns (and any associated campaign-level negative keywords would be applied to individual ad groups 234). Both the campaign building module 230 and the campaign-less hierarchy development module 250 can generically be referred to as a hierarchy development module.

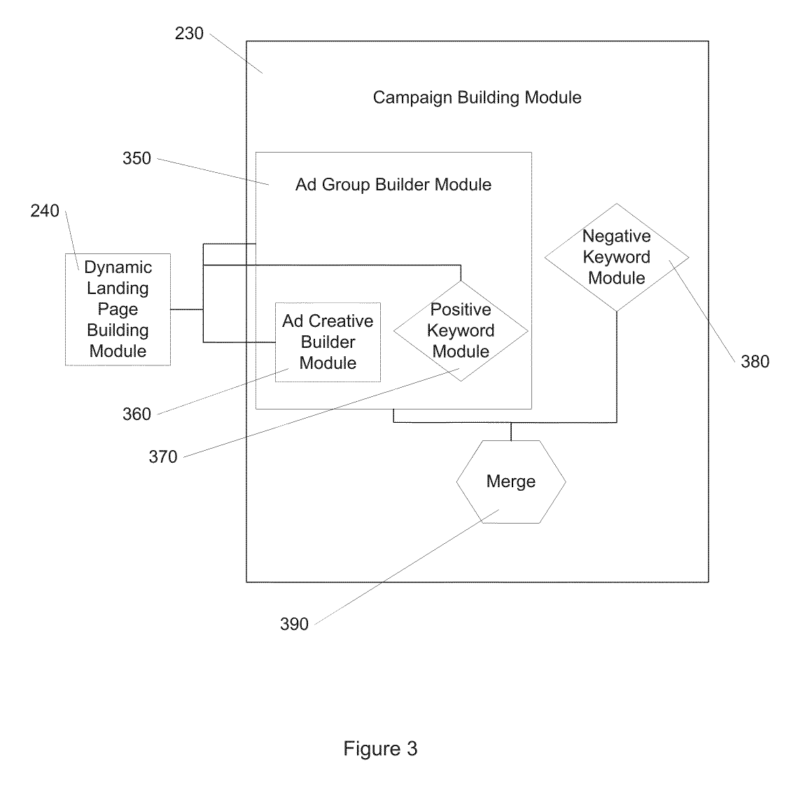

FIG. 4 shows a flowchart for practicing a method representing one embodiment of the present invention. A system or device according to the present invention receives digital vehicle inventory data 410, and identifies the attributes 420 of the vehicles represented. These two steps are updated frequently (often daily) so that the seller's advertisements accurately represent the seller's inventory that is available for sale.

One or more ad campaigns are generated 430, optionally by applying a campaign template for each desired ad campaign. Negative keywords are generated 444, depending on the embodiment, before, after or during ad campaign generation. Depending on the embodiment, ad campaign generation 430 may not be performed as frequently as most of the other steps being described. In certain embodiments, ad campaign generation 430 would be performed once at setup and only updated if the architecture of ad campaigns were changed. Similarly, in certain embodiments that do not use inventory changes to modify negative keyword generation 444, the negative keyword generation 444 may be updated infrequently as well.

Assuming that a pre-arranged ad budget is greater than zero, the first time the campaign building module 230 is activated, at least one ad group is generated 452. The campaign building module 230 will, for a generated ad group, generate positive keywords 442 and generate ad creative 446 for the ad group. For example, if the ad campaign is “Used Make and Model,” an ad group for “Used Toyota 4Runner” will be created if (a) the inventory includes “Toyota” and “4Runner” (regardless of the year and trim), (b) the dealership identified used Toyota 4Runners to be conquested, or (c) the dealer wants to maintain an advertising presence (perhaps because the dealership anticipates acquiring 4Runners in the future). Positive keywords will include “Toyota” and “4Runner,” and negative keywords will include “Chevy” and “Corolla,” since those are potentially associated with other ad groups in the campaign. Similarly, “new” and “SR5” are potentially associated with ad groups in other ad campaigns, and therefore are used as negative keywords. Since a vehicle cannot be both “new” and “used,” the “Used Make Model” campaign should not be used when the positive keyword “new” is used. Even if there is no “Toyota 4Runner” ad group in the “New Make Model” campaign (i.e., the dealership has no new 4Runners in stock, is not conquesting, and has no desire to maintain an ad presence), it would still be a negative keyword because “new” is potentially associated with another ad group.

Similarly, since SR5 (a trim level of the Toyota 4Runner) is a more detailed description of the vehicle, a negative keyword is appropriate. If someone searches for a “used toyota 4runner SR5” then the “Used Make Model Trim” ad campaign is the most relevant. However, a term like “SUV” would not be used as negative keyword. Since “Used Make Model” is more detailed than “Used Make Body,” then someone who searches for “used toyota 4runner SUV” would find the “Used Make Model” ad campaign to be the most relevant.

The method is repeated 450 for additional ad groups for that same ad campaign, and another ad group may be generated, modified or disabled at step 440. The first time the campaign building module 230 is activated for a particular seller, ad groups will only be generated 452. However, as time goes on and as inventory changes, alterations may be necessary. If there are no 4Runners available (and the seller is not interested in conquesting or maintaining an ad presence) then the “Toyota 4Runner” ad group would be disabled 456. Disabling an ad group 448 means either pausing or deleting the ad group. If an ad group is paused, then when another Toyota 4Runner becomes available, the campaign building module 230 will modify 454 the ad group to reactivate it instead of generating 452 the ad group each time a new 4Runner becomes available. Modifications 454 typically do not require new positive keywords be generated, but may require that new ad creative be generated 446 in order to reflect the current inventory. For example, one day there may be five used 4Runners available, and another day there may be six, which may require ad creative generation 446.

Once all of the desired ad groups are generated for the ad campaign (in this example, “Used Make and Model”), the method is repeated 460 to generate a new ad campaign 430. After the initial setup, ad campaigns will typically not be generated, but at step 440, ad groups within each campaign may need to be generated 452, modified 454, or disabled 456.

Once all ad groups for all ad campaigns have been prepared, the ad campaigns are submitted to one or more Internet search engines 480, to allow the ad creative to appear in response to an appropriate Internet search.

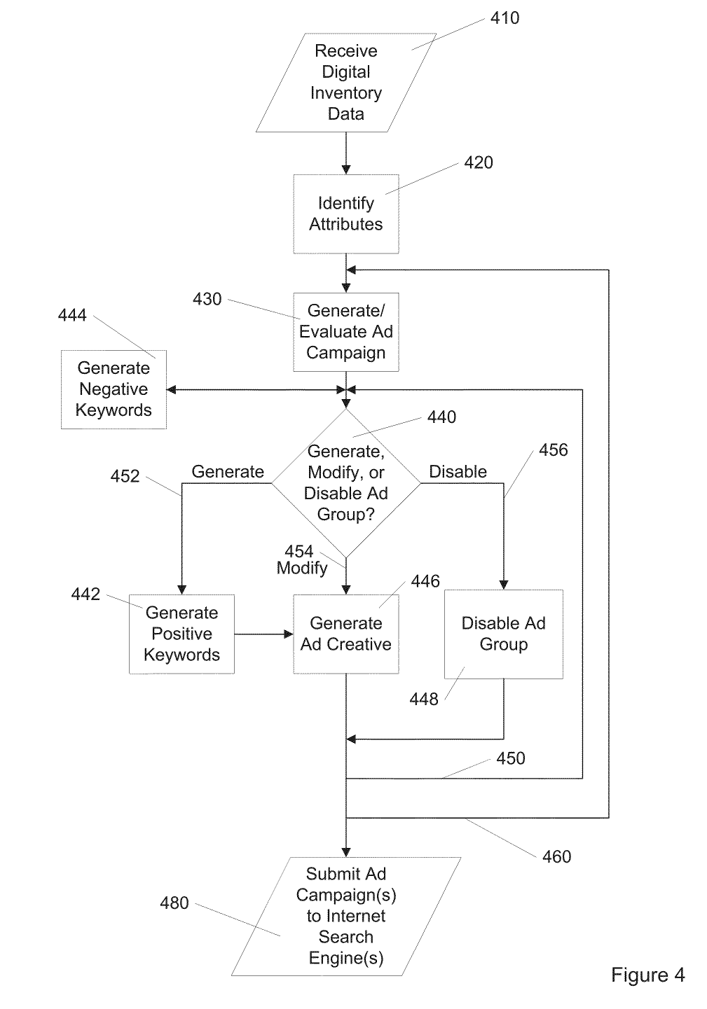

FIG. 5 shows the relationship between certain ad campaigns and sample ad groups. Exemplary ad campaigns can be “Make” 511, “Model” 512, “Make Body” 513, “Make Model” 514, “Year Make Model” 515, or “Year Make Model Trim” 516. Each column is more specific than the preceding column. Year Make Model is less specific than Year Make Model Trim, but more specific than every preceding column. Accordingly, negative keywords associated with columns to the right would be used in preceding columns, but not all negative keywords associated with columns on the left would be used in subsequent columns.

Ad campaign Make 511 could have the ad groups “Toyota” 521 and “Chevy” or “Chevrolet” 531. The name of ad group 531 is merely for organizational simplicity, and it is positive and negative keywords that will determine where a search is directed. It is desirable that all suitable synonyms would serve as positive keywords for appropriate ad groups. Ad campaign Model 512 could have the ad groups “4Runner” 522 and “Malibu” 532. Ad campaign Make Body 513 could have the ad groups “Toyota SUV” 523 and “Chevy Sedan” 533. Ad campaign Make Model 514 could have the ad groups “Toyota 4Runner” 524 and “Chevy Malibu” 534. Ad campaign Year Make Model 515 could have ad groups “2014 Toyota 4Runner” 525 and “2012 Chevy Malibu” 535. Ad campaign Year Make Model Trim 516 could have ad groups “2014 Toyota 4Runner Limited” 526 and “2012 Chevy Malibu LTZ” 536.

Furthermore, the ad campaigns are not restricted to the described facets. Additional features, such as price and color, could be included in the hierarchy. In one embodiment, these new features would be new ad campaigns. For example, if a new ad campaign “Price Make Model” was introduced, possible ad groups might include “Low Priced Toyota 4Runner,” “Mid Priced Toyota 4Runner,” and “Luxury Toyota 4Runner,” which have positive keywords that include phrases such as “$30k-$40k,” “under $20,000,” “cheap,” or the like. An ad campaign such as “Color Make Model” is similarly possible, having ad groups that might include “Red Toyota 4Runner” and “Silver Toyota 4Runner.” If price was determined to be more important than color, then negative keywords associated with the ad groups within the “Price Make Model” ad campaign would be used in the “Color Make Model Campaign” so that a search with both color and price would be excluded from the “Color Make Model” ad campaign and funneled to the “Price Make Model” ad campaign. The relationship could be depicted visually by having the ad campaign “Price Make Model” to the right of the ad campaign “Color Make Model.” In an alternative embodiment the described ad groups could be included in the “Make Model” ad campaign 514. Although such an embodiment would not be able to take advantage of campaign-level negative keywords for color and price, ad-level negative keywords would be able to accomplish the same results.

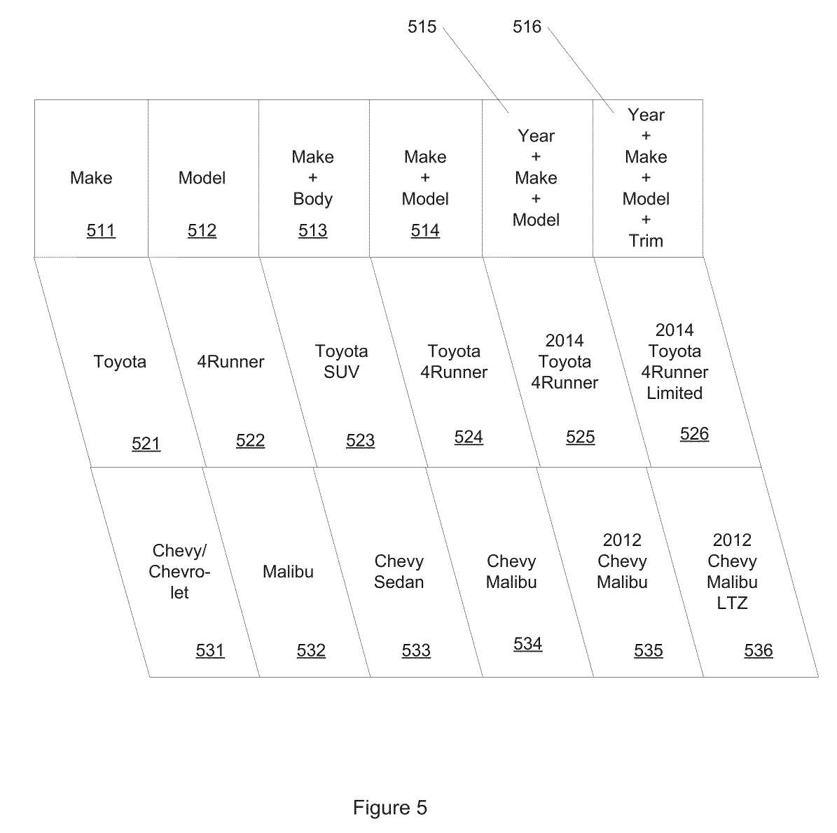

FIG. 6 shows a schematic of an ad group 234. Ad group 234 contains ad creative 650, positive keywords 670 and negative keywords 680. There may be multiple versions of ad creative 650 to improve ad relevancy, which increases the seller's chances of appearing on the first page of an Internet search. Ad group 234 can also include bid information, which is also useful to increase the seller's chances of appearing on the first page of an Internet search.

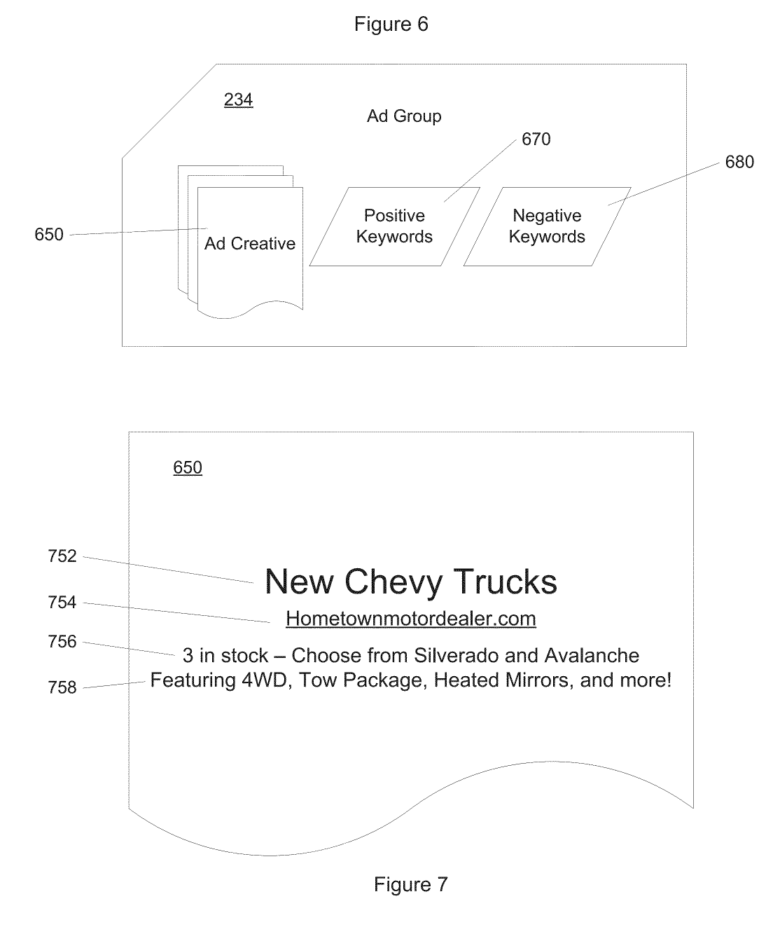

FIGS. 7, 8, and 9 are described in greater detail in connection with the examples that follow.

### EXAMPLE 1

### Three Chevy Trucks for Sale

A hypothetical seller named “Hometown Motors” wishes to optimize Internet search results so that consumers can more easily find and buy its cars. The seller provides digital vehicle inventory data to an Internet ad optimization vendor who operates a system, such as appears in FIGS. 2A or 2B. The system receives the digital vehicle inventory data with its communications module 210, and applies an attribute-identifying template in its multi-value highlights module 220. The data is passed to the campaign building module 230 of FIG. 2A, for example, which communicates with the dynamic landing page building module 240 to build ad campaigns 232, ad groups 234 for each ad campaign 232, and, within each ad group 234, a destination URL that, when followed, will trigger the dynamic landing page building module 240 to create a dynamic landing page 242. A campaign building module 330 as shown in FIG. 3, and a method as outlined in FIG. 4, can be used.

In this example, the seller has inventory that includes three new Chevrolet trucks for sale: two Silverados and one Avalanche. Several [ad campaigns] and (ad groups) are populated, such as:

[New Make] (Chevrolet),

[New Model] (Avalanche) (Silverado),

[New Make Model] (Chevrolet Avalanche) (Chevrolet Silverado),

[New Make Body] (Chevrolet Truck),

[New Year Make Model] (2014 Chevrolet Avalanche) (2014 Chevrolet Silverado),

[New Year Make Model Trim] (2014 Chevrolet Avalanche LTZ 4WD) (2014 Chevrolet Silverado LTZ) (2014 Chevrolet Silverado High Country),

[Combined Model] (Avalanche) (Silverado),

[Combined Make Model] (Chevrolet Avalanche) (Chevrolet Silverado),

[Combined Make Body] (Chevrolet Truck),

[Combined Year Make Model] (2014 Chevrolet Avalanche) (2014 Chevrolet Silverado), and

[Combined Year Make Model Trim] (2014 Chevrolet Avalanche LTZ 4WD) (2014 Chevrolet Silverado LTZ) (2014 Chevrolet Silverado High Country).

FIG. 7 shows an example of an ad creative 650 for the ad group (Chevrolet Truck). In this example, the title 752 is simply “New Chevy Trucks.” However, depending on what the dealership prefers, the title 752 could be “3 New Chevy Trucks,” “Hometown Motors Has It,” “0.9% APR Financing Available,” or any other eye-catching text. Line 754 is a display URL to hometownmotordealer.com. However, the destination URL, which is hidden from view, is a link that has enough information to, once decoded, tell the dynamic landing page building module 240 which ad campaign and ad group is responsible for the ad creative 650. Lines 756 and 758 provide attributes of the vehicles in the ad group associated with ad creative 650. Which attributes, and how to display them, are not limited.

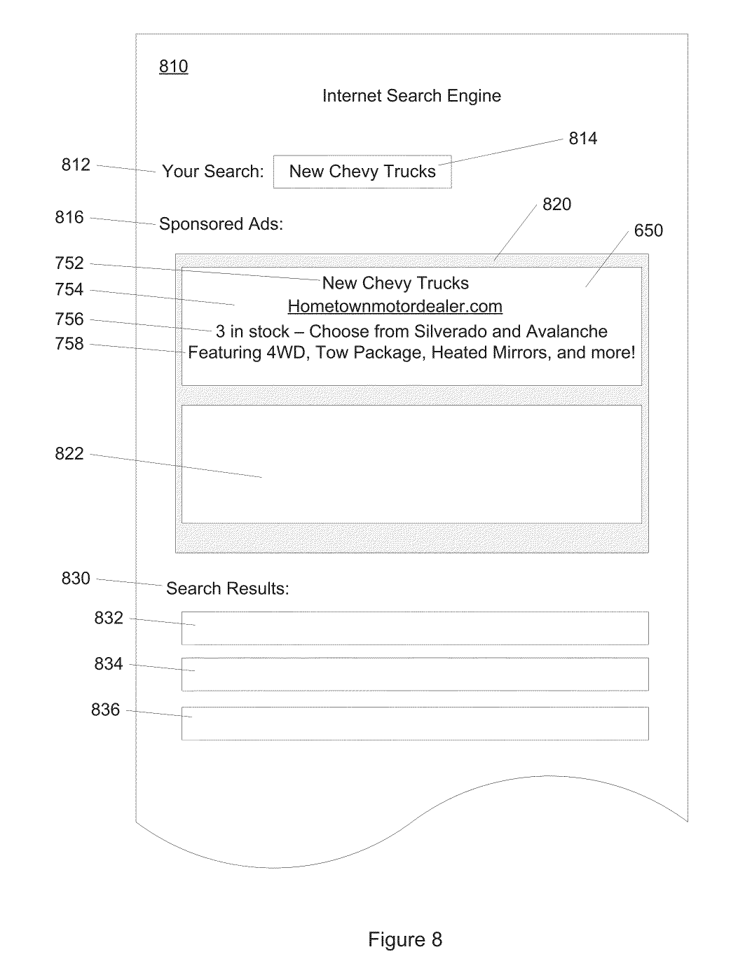

While the configuration, look, and feel of an Internet search engine results page is not limited, one example is shown schematically in FIG. 8. Results page 810 includes a line 812 repeating the search inquiry 814, in this case, “New Chevy Trucks.” Sponsored ads 816 are typically shown in a sponsored ad section 820, and include ad creative 650 and additional sponsored ad(s) 822. Under line 830, organic search results 832, 834, and 836 appear on search results page 810.

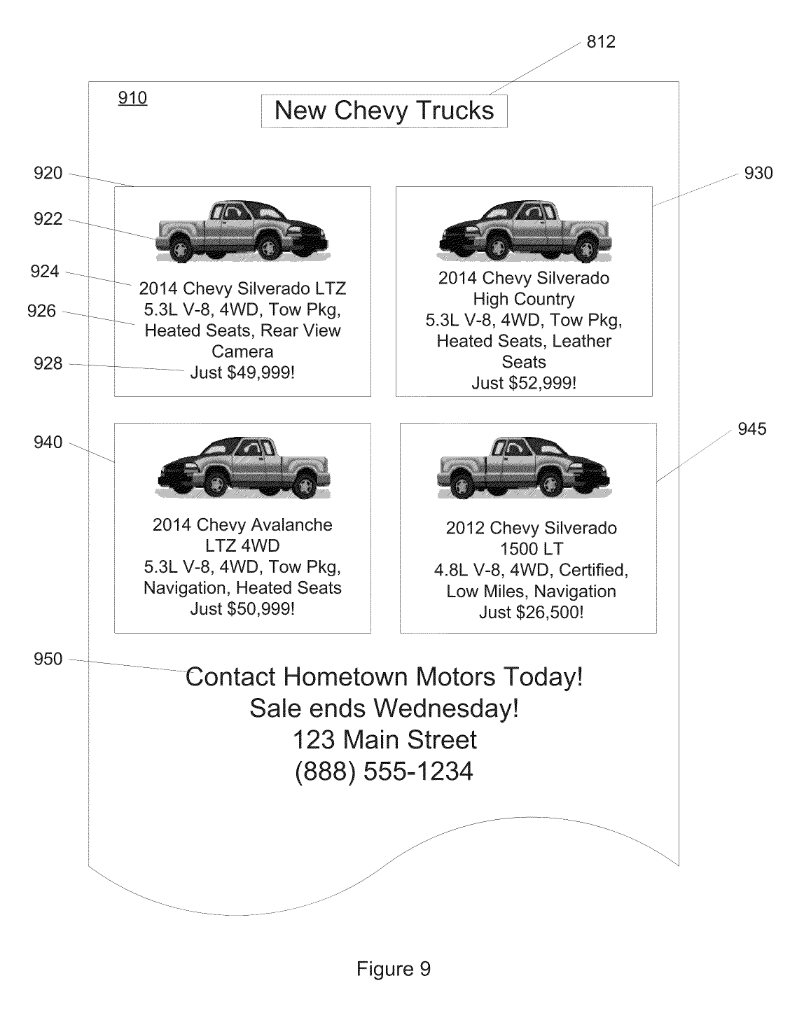

FIG. 9 shows a schematic of a dynamic landing page 910 constructed in accordance with an embodiment of the invention. Dynamic landing page 910 is configured to display in a consumer's browser when the consumer clicks on the display URL 754, shown in FIGS. 7 and 8. In the embodiment shown, the title is constructed from positive key words in the ad group and/or the ad group name in an attempt to use a phrase similar to the search inquiry 814. However, using the exact search inquiry 814 may not be possible if both the destination URL is required to be created when the ad group is updated (i.e., submitted with ad creative 650 before the consumer performs the search) and the Internet search engine does not allow the actual search to be passed to the advertiser.

For each highly relevant vehicle in the seller's digital vehicle inventory data that meets the criteria of the ad group, information 920, 930, and 940 appears. In addition, information 945 on moderately relevant vehicles, which, although not specifically requested, can additionally be displayed. Preferably, the information 945 on other vehicles would be relevant to the search inquiry 814. In the example, a two-year old Chevy Silverado with low mileage is displayed along with the new Chevy trucks in order to give the consumer an opportunity to make a lower-cost purchase from the seller sponsoring the ad campaign.

Information 920, 930, 940 and 945 includes any suitable data selected from the attributes found in the digital vehicle inventory data. For example, information 920 can include a picture or photograph 922 of the vehicle, a name of the vehicle 924, which in this case includes the model year (“2014”), manufacturer name or nickname (“Chevy”), model name (“Silverado”), and trim (“LTZ”). Data 926 include further attributes, and data 928 includes the offer price, MSRP, or sale price. No attribute or data is mandatory in any embodiment, and can be automatically selected by the seller (or service provider assisting the seller in implementing an embodiment of the present invention) based on a ranking of attributes. For example, data 928 could include a statement relating to a mark down, a financing offer, a limited time offer, or any attribute of the vehicle, or data 928 could be omitted, in other instances. Mileage, for example, is typically only relevant for used vehicles and not new vehicles.

Data 950 can include any suitable information, and in this example, includes the name of the dealership (fictional “Hometown Motors”) having the highly relevant vehicles appearing in information 920, 930, and 940 in inventory, moderately relevant vehicle(s) appearing in information 945, and, optionally, a promotional statement (“Sale ends Wednesday!”), location (“123 Main Street”), phone number (“(888) 555-1234”). Optionally, one or more data items in data 950 can be hypertext linked to any suitable site, such as the seller's homepage, sales office, service office, or the like.

As previously stated, detailed embodiments of the present invention are disclosed herein; however, it is to be understood that the disclosed embodiments are merely exemplary of the invention that may be embodied in various forms. It will be appreciated that many modifications and other variations stand within the intended scope of this invention as claimed below. Furthermore, the foregoing description of various embodiments does not necessarily imply exclusion. For example, “some” embodiments may include all or part of “other” and “further” embodiments within the scope of this invention. In addition, “a” does not mean “one and only one;” “a” can mean “one and more than one.”

Accordingly, that which is intended to be protected by Letters Patent is set forth in the claims and includes all variations and modifications that fall within the spirit and scope of the claim. Notwithstanding the foregoing, the claims described in the Letters Patent have been presented with the intent of avoiding the construction authorized under 35 USC § 112(f). Specifically, regardless of whether a claim has functional language, the scope of such a claim is not intended to, in the words of 25 USC § 112(f), “cover the corresponding structure, material, or acts described in the specification and equivalents thereof.” If necessary, and as long as the result is not invalidity, a claim should be interpreted (which may include disregarding formatting such as line indentations) such that either (i) it is not for a combination or (ii) functional elements encompass structure, material, or acts in support thereof.

We claim:

1. A system for optimizing digital ad campaigns for vehicle sales, the system comprising:
a communications module for receiving and sending digital information to one or more computers or devices, receiving digital vehicle inventory data from a seller, and sending one or more ad campaigns to one or more internet search engines;
a multi-value highlights module, in communication with the communications module, for automatically identifying one or more attributes for each vehicle in the digital vehicle inventory data;
a campaign building module, in electronic communication with the multi-value highlights module, for automatically building one or more ad campaigns, each ad campaign comprising one or more ad groups, each ad group being adapted to configure one of the one or more search engines to present ad creative in response to a speculative search containing one or more positive keywords and no negative keywords; and
a negative keyword module, in communication with the campaign building module, for automatically building negative keywords such that the negative keywords that are excluded from a first speculative search within a first ad group within a first campaign include (a) all the negative keywords that are excluded from a second speculative search within a second ad group within a second ad campaign that are not also positive keywords for the first speculative search and (b) all the positive keywords that are contained in the second speculative search that are not also positive keywords for the first speculative search; and
a positive keyword module, in communication with the campaign building module, for automatically building positive keywords for each ad group, the positive keywords associated with the one or more attributes.

2. The system of claim 1, wherein the negative keywords that are excluded from the second speculative search within the second campaign include (a) all the negative keywords that are excluded from a third speculative search within a third ad group within a third ad campaign that are not also positive keywords for the second speculative search and (b) all the positive keywords that are contained in the third speculative search that are not also positive keywords for the second speculative search.

3. The system of claim 1, wherein:
the negative keyword module
applies campaign-level negative keywords to negative keywords that pertain to an entire campaign, and
applies ad group-level negative keywords to negative keywords that do not pertain to an entire campaign, and
whereby the campaign-level negative keywords for the first campaign and the ad group-level negative keywords for the first ad group encompass all the negative keywords that are excluded from the first speculative search.

4. The system of claim 1, wherein the one or more attributes for each vehicle are selecting from the group consisting of: make, model, body, year, trim, and price.

5. The system of claim 1, wherein the one or more attributes for each vehicle are selecting from the group consisting of: make, model, year, body style, trim, interior color, exterior color, mileage, certified status, used status, new status, transmission type, engine, fuel economy rating, brakes, interior features, leather seats, third row seating, navigation system, stereo, satellite radio, wireless connectivity technology, back up camera, sun roof, warranty, price, price relative to average, number of previous owners, and recent maintenance.

6. The system of claim 1, further comprising a dynamic landing page building module in electronic communication with the multi-value highlights module, for generating dynamic landing pages.

7. The system of claim 1, wherein the negative keyword module comprises a master negative keyword list that includes positive keywords for all speculative searches associated with the digital vehicle inventory data.

8. The system of claim 7, wherein the master negative keyword list includes positive keywords for speculative searches that are associated with vehicles not included in the digital vehicle inventory data.

9. The system of claim 1, wherein the campaign building module further comprises an ad creative builder module adapted to prepare the ad creative using the one or more attributes for each vehicle.

10. A system for optimizing digital ads for vehicle sales in response to search queries, the system comprising:
a communications module for receiving and sending digital information to one or more computers or devices, receiving digital vehicle inventory data from a seller, and sending one or more ad groups to one or more search engines;
a hierarchy development module, in communication with the communications module, for automatically building multiple ad groups, wherein each ad group is adapted to configure one of the one or more search engines to present ad creative in response to a search containing one or more positive keywords and no negative keywords;
a negative keyword module, in communication with the campaign building module, for automatically building negative keywords such that the negative keywords that are excluded from a first speculative search within a first ad group include (a) all the negative keywords that are excluded from a second speculative search within a second ad group that are not also positive keywords for the first speculative search and (b) all the positive keywords that are contained in the second speculative search that are not also positive keywords for the first speculative search; and
a positive keyword module, in communication with the hierarchy development module, for automatically building positive keywords for each ad group, the positive keywords associated with the vehicle inventory data.

11. The system of claim 10, wherein the negative keywords that are excluded from the second speculative search include (a) all the negative keywords that are excluded from a third speculative search within a third ad campaign that are not also positive keywords for the second speculative search and (b) all the positive keywords that are contained in the third speculative search that are not also positive keywords for the second speculative search.

12. The system of claim 10, further comprising a multi-value highlights module, in communication with the communications module, for automatically identifying one or more attributes for each vehicle in the digital vehicle inventory data, wherein the one or more attributes for each vehicle are selecting from the group consisting of: make, model, body, year, trim, and price.

13. The system of claim 10, further comprising a multi-value highlights module, in communication with the communications module, for automatically identifying one or more attributes for each vehicle in the digital vehicle inventory data, wherein the one or more attributes for each vehicle are selecting from the group consisting of make, model, year, body style, trim, interior color, exterior color, mileage, certified status, used status, new status, transmission type, engine, fuel economy rating, brakes, interior features, leather seats, third row seating, navigation system, stereo, satellite radio, wireless connectivity technology, back up camera, sun roof, warranty, price, price relative to average, number of previous owners, and recent maintenance.

14. The system of claim 10, further comprising a dynamic landing page building module in electronic communication with the communications module, for generating dynamic landing pages.

15. The system of claim 10, wherein the negative keyword module comprises a master negative keyword list that includes positive keywords for all speculative searches associated with the digital vehicle inventory data.

16. The system of claim 15, wherein the master negative keyword list includes positive keywords for speculative searches that are associated with vehicles not included in the digital vehicle inventory data.

17. The system of claim 1, wherein the hierarchy development module further comprises an ad creative builder module adapted to prepare the ad creative using the digital vehicle inventory data.

18. A system for optimizing digital ads in response to search queries, the system comprising:
a communications module for receiving and sending digital information to one or more computers or devices, receiving digital inventory data, and sending one or more ad groups to a search engine;
a hierarchy development module, in communication with the communications module, for automatically building multiple ad groups, wherein each ad group is adapted to configure the search engine to present ad creative in response to a search containing one or more positive keywords and no negative keywords;
a negative keyword module, in communication with the campaign building module, for automatically building negative keywords such that the negative keywords that are excluded from a first speculative search within a first ad group include (a) all the negative keywords that are excluded from a second speculative search within a second ad group that are not also positive keywords for the first speculative search and (b) all the positive keywords that are contained in the second speculative search that are not also positive keywords for the first speculative search; and
a positive keyword module, in communication with the hierarchy development module, for automatically building positive keywords for each ad group, the positive keywords associated with the inventory data.

19. The system of claim 18, wherein the negative keywords that are excluded from the second speculative search include (a) all the negative keywords that are excluded from a third speculative search that are not also positive keywords for the second speculative search and (b) all the positive keywords that are contained in the third speculative search that are not also positive keywords for the second speculative search.

20. The system of claim 18, further comprising a dynamic landing page building module in electronic communication with the communications module, for generating dynamic landing pages.
